(19) United States
(12) Patent Application Publication
(10) Pub. No.: US 2026/0233431 A1
(43) Pub. Date: Aug. 13, 2026

(54) SLAB CUTTING SYSTEM

(71) Applicant: RAIMONDI S.P.A., MODENA (IT)

(72) Inventor: Riccardo SIGHINOLFI, RUBIERA (RE) (IT)

(21) Appl. No.: 19/155,818

(22) PCT Filed: Jan. 22, 2024
(86) PCT No.: PCT/IB2024/050578

§ 371 Date: Aug. 12, 2025

(30) Foreign Application Priority Data
Feb. 13, 2023 (IT) 102023000002364
Jul. 24, 2023 (IT) 102023000015441

(51) Int. Cl. B28D 1/22; B28D 7/04

(52) U.S. Cl. CPC B28D 1/225; B28D 7/046

(57) ABSTRACT

A slab cutting system (10) comprising: —at least one support (20) configured to rest on a slab (L) to be cut and provided with at least one sliding rail (212) developing along a longitudinal axis (A); —at least one engraving slider (50) provided with at least one engraving wheel (52) rotatable about an axis of rotation orthogonal to the longitudinal axis (A); wherein the engraving slider (50) comprises a connecting assembly (55) interconnecting the engraving slider (50) and the sliding rail (212) for sliding the engraving slider (50) relative to the sliding rail (212) along the longitudinal axis (A) thereof, wherein the connecting assembly (55) comprises at least one first connecting element (551) configured to contact a first contact portion of the sliding rail (212) and at least one second connecting element (552) opposite to the first connecting element (551) and configured to contact a second contact portion of the same sliding rail (212) opposite to the first contact portion in contact with the first connecting element (551), wherein the at least one of the first connecting element (551) and the second connecting element (552) comprises at least one rolling body configured to roll on the sliding rail (212).

### TECHNICAL FIELD

The present invention relates to the field of processing slab-like elements, preferably of large format, such as tiles, glass slabs or the like, generally made of fragile or brittle fracture material. In detail, embodiments of the present invention refer to a slab cutting system, such as for example ceramic slabs.

### PRIOR ART

As is known, hard and brittle fracture materials such as ceramic or glass are widely used in the construction of buildings (for example, as surface coatings) or other products. Such materials are usually produced in slabs of various sizes that can be cut to form formats other than the original one.

In the case of floor coverings or wall coverings, the use of ceramic materials for aesthetic reasons, for a good wear resistance and for easy maintenance thereof is widely wide-spread.

Alongside the most common tiles in ceramic material available in various standardized formats, the use of also large-format slabs (for example, with at least one dimension in the order of the metre), simply referred to as slabs below for brevity's sake, has recently developed.

In detail, portions of desired length/width are obtained from a slab through cutting systems designed to perform a cut (or at least an engraving) of the slab itself.

Given the dimensions of the slabs to be cut, the cutting systems usually comprise a rectilinear longitudinal guide which is arranged on the surface of the slab to be subjected to cutting and an engraving slider movably coupled to the longitudinal guide and made to slide along the guide, while a cutting portion of the engraving slider is kept in contact with the surface of the slab. In this way it is possible to perform a long engraving along an engraving line on the slab, from which it is then possible to propagate the fragile fracture of the slab, for the separation thereof into various portions according to the needs.

A need felt in the sector is to make available a cutting system with excellent functional characteristics, but which can simplify the components, such as the engraving slider or other, so as to be lighter, cheaper and easy to handle.

In addition, a need felt is to make the cutting system adaptable to the various formats and/or configurations of slabs to be cut.

Furthermore, a need felt in the sector is to make available a cutting system that is more cost-effective and/or that allows to save raw materials for the production thereof, as well as lighter (for transport) and easier to handle than commercially known cutting systems.

In addition, a need felt in the sector is to make the cutting system perform better, with the same amount of thrust exerted by the user on the engraving slider.

### DISCLOSURE OF THE INVENTION

An object of the present invention is to meet these and other needs of the prior art, within the framework of a simple, rational and cost-effective solution.

These objects are achieved by the features of the invention set forth in the independent claim. The dependent claims outline preferred and/or particularly advantageous aspects of the invention.

The invention particularly makes available a slab cutting system comprising:
at least one support configured to rest on a slab to be cut and provided with at least one sliding rail developing along a longitudinal axis;
at least one engraving slider provided with at least one engraving wheel rotatable about an axis of rotation orthogonal to the longitudinal axis;
wherein the engraving slider comprises a connecting assembly interconnecting the engraving slider and the sliding rail for sliding the engraving slider relative to the sliding rail along the longitudinal axis thereof, wherein the connecting assembly comprises at least a first connecting element configured to contact a first contact portion of the sliding rail (and, for example, configured to at least partially embrace the sliding rail) and at least one second connecting element (diametrically) opposite (with respect to the longitudinal axis of the sliding rail) to the first connecting element and configured to come into contact with a second contact portion of the same sliding rail (diametrically) opposite to the first contact portion in contact with the first connecting element (e.g., the one embraced by it), wherein at least one of the first connecting element and the second connecting element comprises at least one rolling body configured to roll (without dragging) on the sliding rail (i.e. on the respective contact portion thereof).

Thanks to this solution, it is possible to achieve the aforementioned objects.

In particular, thanks to this configuration, it is possible to achieve a simplification of the structure with the same functionality and, therefore, savings in terms of costs and raw materials used, as well as to achieve a greater user comfort and a more performing system.

Advantageously, the connecting assembly may interconnect the engraving slider and the single sliding rail, and the connecting assembly may define a shape constraint with the single sliding rail configured to allow axial sliding of the engraving slider along the longitudinal axis of the sliding rail and prevent translations of the engraving slider in any direction orthogonal to the longitudinal axis of the sliding rail.

Thanks to this solution, the connection between the engraving slider and the sliding rail is particularly stable and results in a high engraving precision and handling.

Still, the shape constraint may be configured to allow an oscillation about the longitudinal axis of the sliding rail.

Thanks to this, it is possible to easily translate the engraving slider along the longitudinal axis even when it is not necessary to make the engraving (such as in the steps of positioning the engraving slider) without scoring the slab, for example by simply rotating the engraving slider upwards and detaching the engraving wheel from the slab during such movements preparatory to the actual engraving and/or it is possible to determine the suitable depth/engraving force.

Advantageously, at least one of the first connecting element and the second connecting element can be configured to at least partially embrace the sliding rail.

Thanks to this solution it possible to make available a stable connection that cannot be radially removed from the sliding rail.

Advantageously, the axis of rotation of the engraving wheel can be fixed relative to the engraving slider.

In this way, the configuration of the engraving slider is made particularly simple and, in any case, effective.

According to one possible embodiment, one of the second connecting element and the first connecting element may comprise a sliding shoe (opposite to the rolling body), which is configured to drag on the sliding rail.

In an alternative embodiment, both the second connecting element and the first connecting element can comprise at least one respective rolling body configured to roll on the sliding rail, e.g. around rolling axes orthogonal to the longitudinal axis of the sliding rail and, preferably (but not limited to), parallel to each other.

Advantageously, the rolling body can comprise at least one concave-profile wheel or one flat-profile wheel for contact (circumferentially extended or punctual, respectively) on the sliding rail.

For example, the aforementioned sliding shoe (where provided) may comprise a concave profile or a flat profile (circumferentially extended or punctual respectively) for contact on the sliding rail.

In addition, at least one of the first connecting element and the second connecting element can be movable closer to and/or away from the other of the second connecting element and the first connecting element, in order to adjust a gripping force on the sliding rail.

Adjusting the gripping force makes it possible to reduce/adjust/eliminate any (radial) clearance in the connection between the connecting assembly (i.e. the first and second connecting elements) and the sliding rail, and, for instance, makes it also possible to adjust the slidability of the engraving slider on the sliding rail.

A reduction/elimination of the (radial) clearance results in greater engraving accuracy by the engraving slider.

A greater gripping force of the connecting assembly on the sliding rail results in a greater grip or friction of the first and second connecting elements on the (surface of the) sliding rail and, therefore, in a lower slidability or greater resistance to slidability or otherwise a control over the slidability (which is appreciated, as it results in a greater control by the user over the engraving slider during engraving and/or during positioning thereof). The gripping force can then be adjusted and calibrated, as desired, so that the engraving slider has a desired slidability (depending on the user's needs) and has no (radial) clearance in relation to the sliding rail and, for example, is substantially robust or “firm” in its movement or has a comfortable, pleasant and precise response for the user.

Advantageously, (for this purpose) the engraving slider and/or connecting assembly can comprise adjustment means configured to adjust and lock the mutual distance between the first connecting element and the second connecting element and/or the gripping force thereof on the connecting rail.

Advantageously, the rolling body (which defines at least one of the first connecting element and the second connecting element or, preferably, both) can comprise at least one ball or a row of balls, wherein preferably the connecting assembly and/or at least one of the first connecting element and the second connecting element comprises a recirculating ball bearing.

According to one aspect of the invention, the support can comprise at least one longitudinal guide bar and the sliding rail preferably develops over the entire longitudinal development of the guide bar, wherein preferably the sliding rail has a constant cross-section throughout its development, even more preferably substantially circular.

In such a case, the system can comprise a plurality of guide bars and interconnecting means configured to releasably interconnect two consecutive and coaxial guide bars to each other.

Thanks to this solution it is possible to extend the guide bar in the longitudinal direction by adapting it to various slab formats and, therefore, allowing longitudinal engravings of even greater length than the length of a single guide bar.

At the same time, once disassembled, the various guide bars are easily transportable and can reduce their axial encumbrance.

Furthermore, at least one suction cup can be connected to the support for temporarily and releasably fixing the support to the slab.

Further, the suction cup can comprise a (elastically deformable) plate from which a traction stem is derived and an abutment cup, wherein the abutment cup is defined as integral or rigidly attached to a lower surface of the support intended to face the slab.

In addition, the traction stem can be connected to traction means, preferably cam means, arranged above an upper surface of the support opposite to the lower surface.

Furthermore, advantageously, at least one of the plate and the abutment cup of the suction cup can comprise an element, such as a rest foot or a detachment relief, overlooking the slab and configured to forcibly contact the slab (e.g., in the case of the rest foot of the abutment cup, even when the plate is in a deformed gripping configuration on the slab and during the transitional steps of passing between the deformed and undeformed configurations) and to ease the detachment of the plate from the slab by exerting a thrust away from it when the plate is brought into an undeformed release configuration.

Advantageously, the substrate can comprise a lower surface intended to face the slab, wherein the lower surface comprises at least one rest foot, preferably a single rest foot, wherein the rest foot is preferably made of a yielding and/or elastic and/or adhesive material or other material configured to grip the slab without damaging it.

Furthermore, the rest foot may be elongated and have a longitudinal development parallel to the longitudinal axis of the sliding rail, wherein preferably the longitudinal development of the rest foot may be continuous and equal to the longitudinal development of the sliding rail or, preferably in case there is a pair of rest feet, one of the two rest feet, advantageously the one distal from the engraving wheel of the engraving slider, may be discontinuous in segments and extend over the entire longitudinal development of the sliding rail unless there are contained segments of discontinuity.

The discontinuity of the rest foot (and therefore of the guide bar) is such that it lightens the system.

Furthermore, the rest foot may be placed at a (single) flank/side of the support proximal to the engraving wheel or the support may have a pair of rest feet placed on opposite sides of the support (one of which is proximal to the engraving wheel and the other distal thereto).

Advantageously, the engraving slider may comprise a handle, wherein the handle comprises at least one of a knob and an anatomical housing for gripping and/or housing by a user's hand, wherein the handle is made in a separate body and fixed to the engraving slider or is made in a single body with it.

Further, the suction cup can comprise a plate (elastically deformable) for gripping the slab, which plate has at least one portion protruding externally, preferably laterally, from the support, e.g. this protruding portion comprising a tab for gripping (using two fingers of a user) and operable for detaching the plate from the slab.

Preferably, these tabs are accessible (and protruding externally from the support and/or guide bar) at the discontinuous segments of the rest foot (where provided, and the corresponding notches present on the guide bar).

### BRIEF DESCRIPTION OF THE DRAWINGS

Further features and advantages of the invention will be more apparent after reading the following description provided by way of a non-limiting example, with the aid of the figures shown in the accompanying tables.

FIG. 1 is an axonometric view of a system according to the invention.

FIG. 2 is an enlargement of detail Il of FIG. 1.

FIG. 3 is a view of the detail of FIG. 2 in the assembled configuration.

FIG. 4 is an enlargement of detail IV of FIG. 1.

FIG. 5 is a side view of a detail A of FIG. 4.

FIG. 6 is a front view of FIG. 5.

FIG. 7 is a sectional view along the section trace VII-VII of FIG. 5.

FIG. 8 is a sectional view along the section trace VIII-VIII of FIG. 1.

FIG. 9 is a sectional view along the section trace IX-IX of FIG. 1.

FIG. 10 is a cross-sectional view of a system according to an alternative embodiment, which differs from the previous ones due to the different guide bar and suction cup.

FIG. 11 is a view of FIG. 10 with the gripped suction cup.

FIG. 12 is a front view of the system of FIG. 10.

FIG. 13 is a front view of a further alternative embodiment of the system that differs from the previous ones in the different suction cup.

FIG. 14 is an axonometric view from above of a first embodiment of an engraving slider of the system according to the invention.

FIG. 15 is an axonometric view from below of FIG. 14.

FIG. 16 is an exploded view of FIG. 14.

FIG. 17 is a front view of the system according to the invention provided with the engraving slider of FIG. 14, in a working position.

FIG. 18 is a view of FIG. 17 with the engraving slider in a rest position.

FIG. 19 is a side view of a system according to the invention provided with an engraving slider according to a variant of the first embodiment.

FIG. 20 is a front view of FIG. 19.

FIG. 21 is a front view of the system according to the invention with a second embodiment of an engraving slider.

FIG. 22 is a front view of the system according to the invention with a third embodiment of an engraving slider.

FIG. 23 is a front view of the system according to the invention with a fourth embodiment of an engraving slider.

FIG. 24 is a front view of the system according to the invention with a fifth embodiment of an engraving slider.

FIG. 25 is an axonometric view of an engraving slider according to a sixth embodiment.

FIG. 26 is a front view of FIG. 25.

FIG. 27 is an axonometric view of a variant of the system according to the invention.

FIG. 28 is a view from above of a portion of FIG. 27.

FIG. 29 is an axonometric view from above of an enlarged detail of FIG. 27.

FIG. 30 is an axonometric view from below of the detail of FIG. 29.

FIG. 31 is a sectional view along the section trace XXXI-XXXI of FIG. 28.

FIG. 32 is a sectional view along the section trace XXXII-XXXII of FIG. 28.

FIG. 33 is a sectional view along the section trace XXXIII-XXXIII of FIG. 27.

FIG. 34 is a sectional view along the section trace XXXIV-XXXIV of FIG. 27.

### BEST MODE TO IMPLEMENT OF THE INVENTION

With particular reference to such figures, a cutting system for slabs L, preferably ceramic (or glass or similar) slabs, for example large-format slabs (wherein for example the slab has a size substantially comprised between 3-3.5 metres×1-1.5 metres) has been globally indicated with 10.

The system 10 comprises a support 20 configured to rest on a slab L to be cut.

The support 20 is elongated along a longitudinal axis A, for example rectilinear.

The support 20, in a preferred embodiment (shown in the figures) comprises or consists of at least one longitudinal guide bar 21.

The guide bar 21, for example, has a length greater than a width (in turn greater than a height).

Preferably, the guide bar 21 is defined by a long and thin (for example metallic) side member (for example obtained by extrusion, i.e. having a constant section over the entire longitudinal development) defining an upper (free) surface and an opposite lower surface intended to face a surface of the slab L (resting thereon, directly or indirectly), in particular the visible surface of the slab L, i.e. that surface of the slab L which—once laid—is visible.

In the embodiments shown in the figures, the guide bar 21 has a substantially trapezoidal, preferably isosceles, or triangular, e.g. scalene, (or other) cross-sectional profile.

Preferably, the guide bar 21 has a hollow profile (i.e. provided with an axial cavity throughout its development), preferably defining a channel (open below, i.e. towards the slab L), e.g. provided with a reinforcing wall (or more).

It is not excluded, however, that the longitudinal guide bar 21 may have a cross-section of any shape depending on the needs.

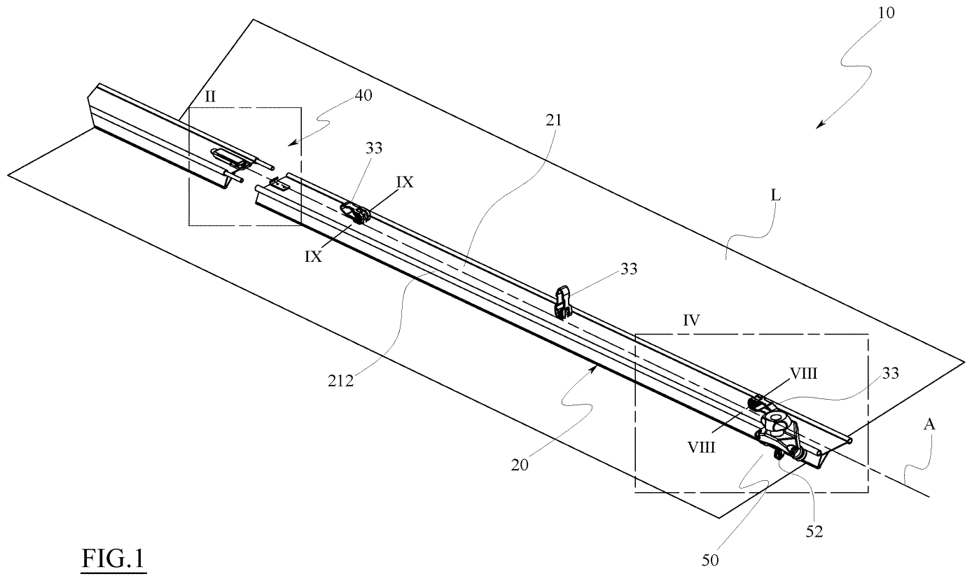

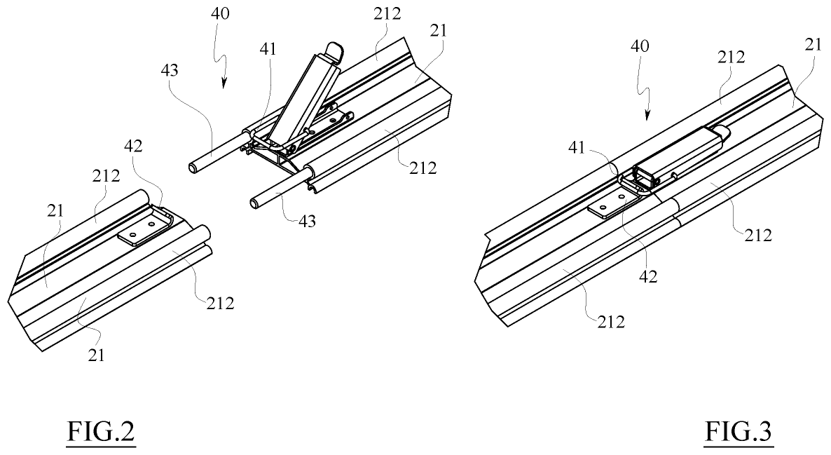

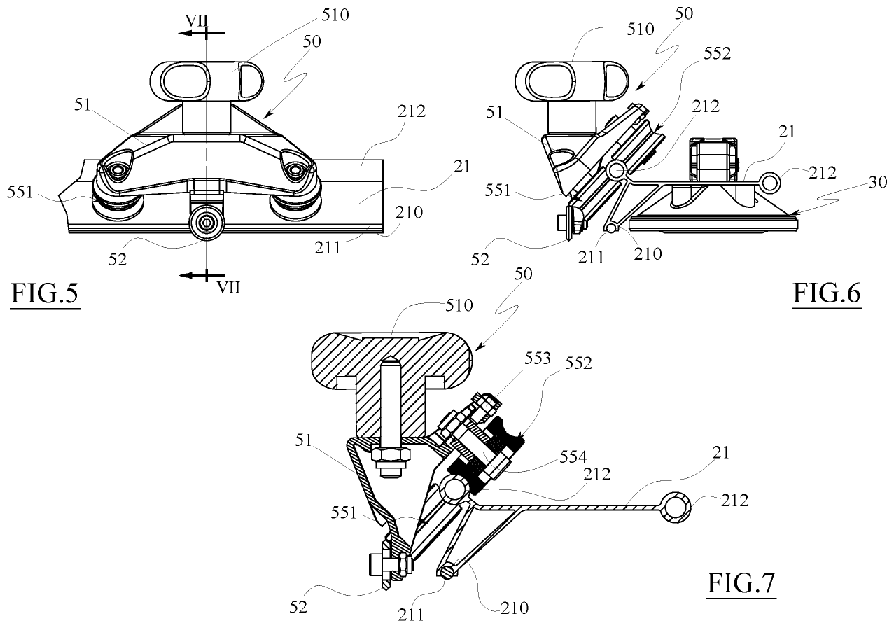

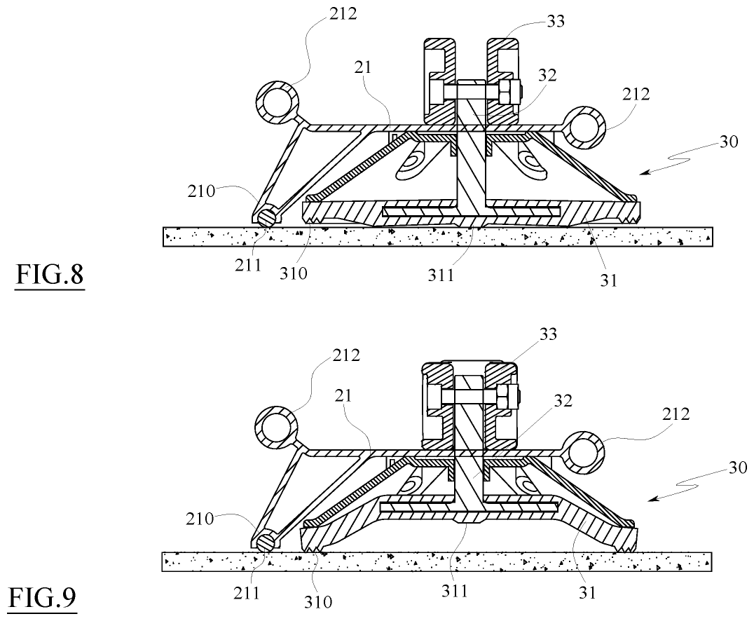

In the preferred example shown in FIGS. 1-9 and 13 (as well as 17-24), the guide bar 21 has a substantially triangular, scalene (open below) cross-sectional profile, e.g. formed by a first upper flap (or smaller base) (intended to be arranged substantially parallel to the visible surface of the slab L on which it rests) and a second inclined flap (or inclined side) (forming an obtuse angle (between 90° and 180°) with the first flap).

In practice, the longitudinal bar 21 has a substantially square shape.

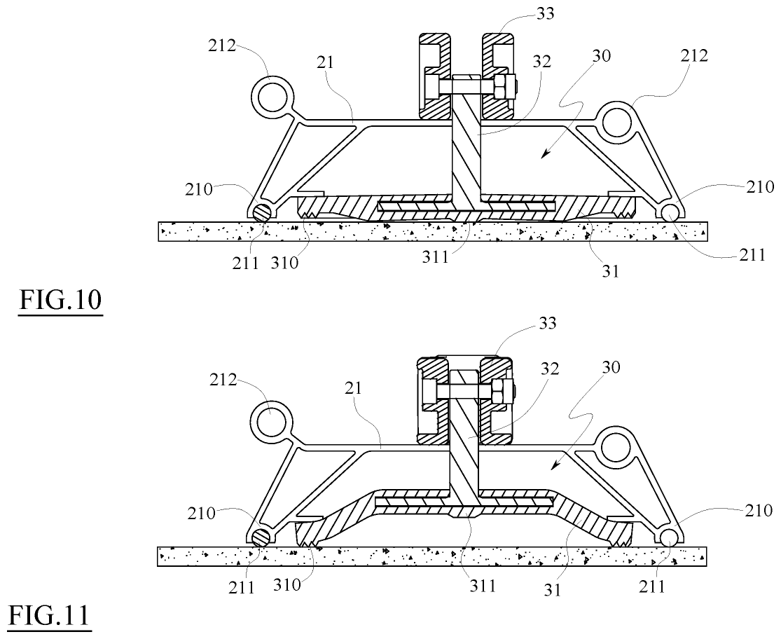

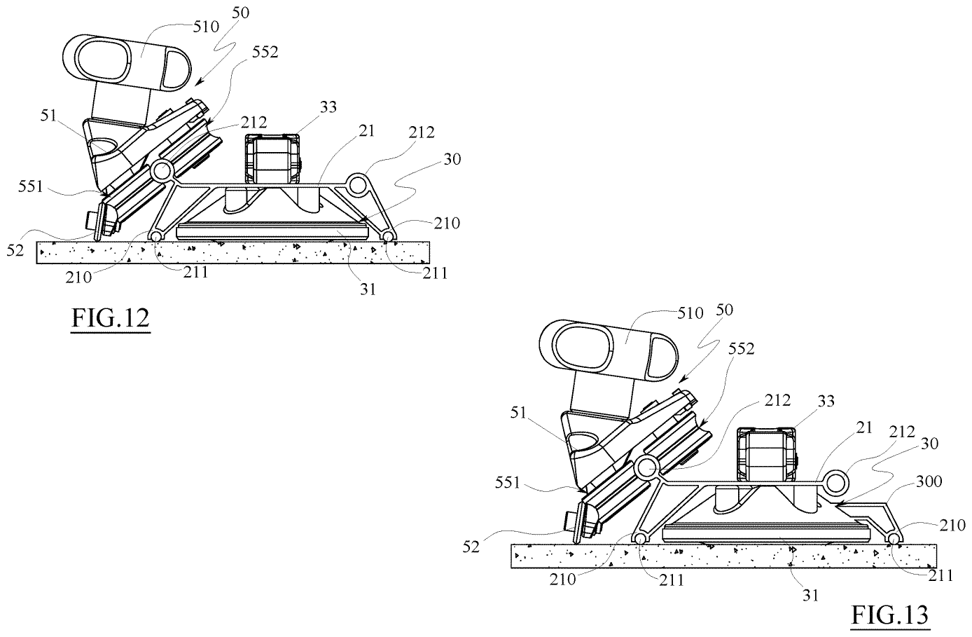

In the example shown in the FIGS. 10-12, the guide bar 21 has a substantially trapezoidal (of an isosceles trapezoid) shape (i.e. a cross-sectional profile), with two opposite inclined sides symmetrical to a longitudinal median plane of the smaller base.

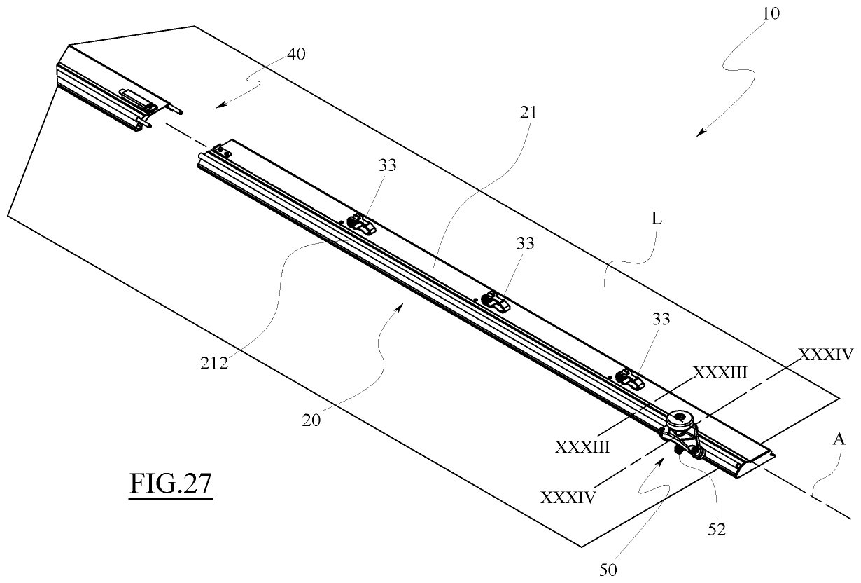

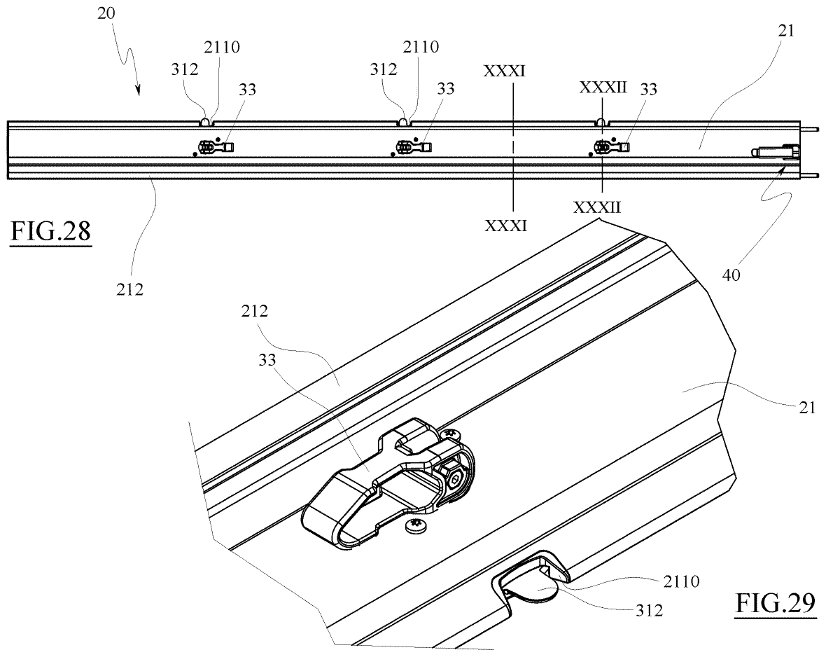

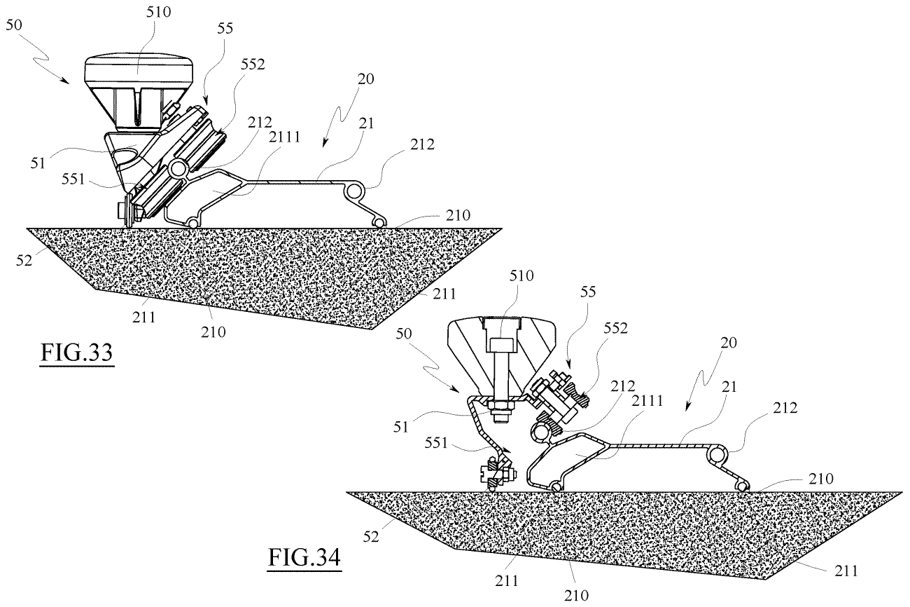

In the example shown in FIGS. 27-34, the guide bar 21 has a substantially trapezoidal (of a scalene trapezoid) cross-sectional profile, with two opposite inclined sides (not symmetrical with respect to a longitudinal median plane of the smaller base).

The guide bar 21 is substantially rigid, i.e. not deformable to the usual stresses to which it is normally subjected during the use for which it is intended.

The guide bar 21, for example, comprises a (first) upper extrados surface (preferably, comprising/formed of the smaller base and at least one of the inclined sides of the trapezoidal/triangular section), and an opposite (second) lower intrados surface.

In practice, the lower surface is intended, in use, to be turned and facing the visible surface of the slab L.

Preferably, the lower surface comprises a central portion (defined by the inner surface of the smaller base), that is preferably plane (planar), for example throughout its development, which defines a plane that is intended to be turned to (and be substantially parallel to) the visible surface of the slab L.

Advantageously, the lower surface comprises at least one edge portion (or side portions), e.g. defined by the inner surface of an inclined side.

In practice, in the preferred example (shown in FIGS. 1-9 and 13, as well as 17-24), the guide bar 21 comprises a single inclined side (and thus a single edge portion of the lower surface).

It is not excluded, however, that—as shown in FIGS. 10-12 and in FIGS. 27-34—the guide bar 21 comprises two inclined sides placed on opposite sides relative to the smaller base (and symmetrical with respect to the longitudinal median plane thereof), in which case the lower surface (as well as the upper surface) comprises two opposite edge portions placed on the opposite side of the central portion (with respect to a flanking direction orthogonal to the longitudinal axis of the guide bar 21).

Preferably but not in a limiting manner, the (or each) edge portion is overlooking (below) relative to the central portion.

One or each edge portion of the lower surface comprises at least one housing 210 (single or double), preferably extending longitudinally throughout its development with respect to the guide bar 21, which is for example defined by one or more longitudinal seats, for example concave with a concavity—in use—towards the visible surface of the slab L.

Preferably, the housing 210 is at the free end of the (respective) inclined side.

Preferably, the support 20 (i.e. the guide bar 21) rests on the slab L by means of one or more rest feet 211, which are fixed for example to the lower surface of the guide bar 21.

Each rest foot 211, for example, is yieldable, preferably elastically (e.g. made of an elastomeric material).

For example, each rest foot 211 is fixed (e.g., in a removable/replaceable manner) within a respective housing 210 (e.g., defining a gasket).

For example, each rest foot 211 extends over the full length of the housing 210 and/or guide bar 21 or over a prevailing length thereof.

For example, each rest foot 211 is substantially cylindrical (or prismatic), with a central axis parallel to the longitudinal axis A of the guide bar 21.

At least one circumferential portion of each rest foot 211 protrudes transversely (towards the slab L) with respect to/below the central portion of the lower surface of the guide bar 21 and/or from the respective housing 210.

In this way, the guide bar 21 rests (in a floating and stable way) on the slab L by means of the rest foot 211, which defines a resilient rest plane (which adapts to the conformation of the visible surface of the slab L) for the support 20/the guide bar 21 on the slab L.

In the preferred example shown in FIGS. 1-9 and 13 (as well as 17-24), the guide bar 21 comprises a single rest foot 211 (placed inside the only housing 210 defined in the only inclined side of the guide bar 21).

It cannot be excluded that the single inclined side comprises two parallel housings, within each of which a respective rest foot 211 is inserted.

Furthermore, it cannot be excluded that—as shown in FIGS. 10-12 and FIGS. 27-34—each of the (two) inclined sides has (at the lower free end, i.e. distal from the smaller base) a respective housing 210 (parallel to each other) within each of which a respective rest foot 211 is inserted, placed opposite (and symmetrical) to the longitudinal median plane of the guide bar 21 (orthogonal to the visible surface of the slab L on which they rest).

Each rest foot 211 also defines an anti-friction and/or anti-slip element for the guide bar 21 on the slab L (having a sliding friction coefficient greater than the sliding friction coefficient of the metallic guide bar 21—i.e. of its edge portion).

Furthermore, the rest foot 211 prevents a direct contact between the lower (rigid, for example metallic) surface of the guide bar 21 and the underlying slab L, thereby avoiding compromising the slab L (for example, scratch formation) due to a friction between the latter and the guide bar itself.

The rest foot (feet) 211 actually define(s) a rest (soft and/or resilient) plane for the guide bar 21 on the visible surface of the slab L.

As shown with reference to the embodiment shown in FIGS. 27-34 (which may, however, apply to all embodiments, such as that shown in FIGS. 10-12), at least one of the two inclined sides (preferably only one of the two) has a plurality of notches 2110 or slits (at or near the free end thereof), which preferably interrupt (with axially contained gaps) the respective rest foot 211 (and the respective housing 210).

In practice, said rest foot 211 (and the respective housing 210) is discontinuous in segments along the longitudinal axis of the guide bar 21, having axial breaks at each of the notches 2110.

The axial position, the function and the number of each notch 2110 will be further clarified below.

In alternative embodiments not shown in the figures, one or more of the housings could be arranged transversely, for example orthogonally, to the longitudinal axis of the guide bar 21.

In this case, each rest foot accommodating in the respective housing extends (preferably parallel to the others), for example over the entire width of the guide bar 21.

In such a case, the rest feet may be more than two in number (for example equidistant between them along the length of the guide bar 21).

On the upper surface of the guide bar 21 there is formed at least one sliding rail 212 which preferably develops along a longitudinal (rectilinear) axis parallel to (or coincident with) the longitudinal axis A of the guide bar 21.

The sliding rail 212 extends in length, preferably, along the entire length of the guide bar 21 (and has two free ends, for example coincident with the free ends of the guide bar 21). For example, as illustrated in the preferred embodiment shown in the figures, the sliding rail 212 can be defined by a cylindrical body (with circular section) joined, at an arc of generatrices (such as lower than 180°, preferably lower than 90°), to the upper surface of the guide bar 21 by a fixing root (longitudinal throughout its development), which for example derives from a vertex between the smaller base and a (single) inclined side of the trapezoidal/triangular section of the guide bar 21 and/or is part of that vertex.

In such embodiments, the sliding rail 212 has a convex cylindrical (outer) sliding surface. For example, the inclined side having the notches 2110 (where provided) is the one opposite to that from which the sliding rail 212 is derived (or is proximal).

In other embodiments not shown, the sliding rail 212 can be defined by a prismatic body (with any section, such as quadrangular/square) joined, at an edge portion, to the upper surface of the guide bar 21 by a fixing root (longitudinal throughout its development), which for example derives from a vertex between the smaller base and an inclined side of the trapezoidal section of the guide bar 21 and/or is part of said vertex.

Also in this case, the sliding rail 212 can have a convex prismatic (outer) sliding surface. The sliding rail 212 (and, for example, the entire support 20 or the entire guide bar 21) is made of metal, preferably aluminium.

Preferably, at least the inclined side of the guide bar 21 proximal to the sliding rail (or both inclined sides), as for example shown in FIGS. 27-34, has an enlarged section, which preferably encloses therein a (single) longitudinal chamber 2111, longitudinal throughout its development, from a lower wall of which the housing 210, within which the rest foot 211 is housed, departs and from an upper wall of which the (fixing root of the) sliding rail 212 departs.

Preferably, the guide bar 21 comprises two sliding rails 212 parallel to (and spaced apart from) each other.

The sliding rails 212 are preferably arranged on opposite sides with respect to a longitudinal median plane of the guide bar 21, or rather of the smaller base thereof, which is parallel to the longitudinal axis A thereof and, for example, orthogonal to the central portion of the lower surface of the guide bar 21, or orthogonal to the visible surface of the slab L on which the guide bar 21 rests.

In the example, the two sliding rails 212 are asymmetrical to each other with respect to this median plane (it is not excluded that they may be symmetrical to each other with respect to this median plane).

In the example illustrated in FIGS. 27-34, one of the sliding rails 212 (i.e. the one joined to the inclined side having the enlarged section) protrudes above (the plane defined by) the smaller base, while the other sliding rail 212 (the one proximal to the inclined side provided with the notches 2110) is placed (at the intersection of the inclined side and the smaller base) below the smaller base.

In practice, the additional sliding rail 212 (located below the smaller base) is defined by a rounding of the corner between the smaller base and the inclined side (provided with notches 2110).

For example, in this connection zone between the smaller base and the inclined side (provided with the notches 2110 within the dihedral angle, a further chamber (with a smaller volume) longitudinal, throughout its development, is defined, for example cylindrical (open at the opposite axial ends), the function of which will be better clarified below. The further longitudinal chamber is similar in shape (and size) to the inner cavity provided in the sliding rail 212 (which protrudes above the plane defined by the smaller base).

The function of this further longitudinal chamber and the inner cavity of the sliding rail 212 (both cylindrical or prismatic in the examples) will be made more evident hereinafter.

The sliding rail 212 (which protrudes above the plane defined by the smaller base e) that is proximal to the inclined side of the enlarged section is, for example, defined externally (in orthogonal projection) with respect to the rest foot 211 of the respective inclined side, i.e. its (orthogonal) projection on the slab L is external with respect to the space between the two rest feet 211.

Preferably, but not limitedly, the sliding rail 212 (i.e. its inner side facing the smaller base and/or the other sliding rail) is substantially tangent to the tangency plane orthogonal to the rest plane defined by the rest feet 211 that externally touches the rest foot 211 proximal thereto (see, for example, FIG. 31).

For example, the two sliding rails 212 can, globally, define a sliding track, which can be engaged by suitable sliding means of a cutting tool, such as (a suitable carriage supporting) a circular cutting saw or bevelling machine or other suitable tool, to perform a straight cut of the slab L.

In practice, said sliding means of such a cutting tool (not shown), used as an alternative to an engraving slider, which will be described below, simultaneously engage both the sliding rails 212 to support the cutting tool itself and allow it to slide axially on its sliding track.

Such a suitable carriage may be provided with a connecting body (as will be described hereinafter) with the addition of a further rolling/supporting and balancing member adapted to make (rolling) contact and anti-tilting restraint with the rolling rail 212 (located on the opposite side to that engaged by the connecting body, i.e. the one arranged below the smaller base in the example illustrated in FIGS. 27-34).

Furthermore, it is not excluded that the support 20 can be defined by one or more support blocks (for example two end rest blocks) which support or are joined to the opposite axial ends of one or more (for example two) sliding rails, for example each defined by a longitudinal sleeve or a longitudinal (cylindrical or prismatic) bar.

The support blocks comprise lower (direct or indirect) rest surfaces on the (visible surface of the) slab L.

In this case the rest feet can be fixed (in a removable/replaceable manner) to the lower surface of the support blocks, so that the same (and therefore the support) is supported restingly on the slab L by the (resilient) rest feet.

The longitudinal sleeve or the longitudinal bar is supported at a non-zero distance from the visible surface of the slab L by the support blocks (and parallel to said visible surface).

The system 10 comprises at least one suction cup 30 which is connected to the support 20 for the temporary and releasable fixing of the support itself to the slab L, i.e. to the visible surface of the slab itself.

The suction cup 30 defines a temporary and releasable gripping and anchoring member, which anchors the support 20 (i.e. the guide bar 21) to the slab L, so as to keep the support 20 fixed with respect to the slab L during the cutting/engraving operations of the slab itself implemented by the system 10.

The suction cup 30 is fixed at the lower surface (for example at the central portion thereof) of the support 20, for example of the guide bar 21 (or of the support block), as will best appear hereinafter.

It is not excluded that in certain circumstances, the suction cup can be flanked to the support, i.e. to the guide bar, in a flanking direction orthogonal to the longitudinal axis A thereof (and parallel to the rest surface thereof on the slab L).

The suction cup 30 comprises, for example, a gripping plate 31, for example circular.

The plate 31 is for example made of an elastically yieldable material, for example of rubber.

Preferably, the plate 31 is a single piece.

Advantageously, the plate 31 is predominantly (e.g. by more than 50 per cent) contained laterally in the side encumbrance of the guide bar 21.

In the example shown in FIGS. 1-9 and 13 (as well as 17-24), the plate 31 protrudes laterally slightly (by a contained sector) outside the guide bar 21, on the side opposite the part wherein the (only) rest foot 211 is provided.

Also in the example shown in FIGS. 27-34, the plate 31 protrudes laterally slightly (by a small sector) out of the guide bar 21, at (the respective) notch 2110. In practice, a part of the suction cup 30, better of the plate 31, protrudes from the notch 2110, so that it can be gripped manually to facilitate its detachment from the slab L.

In such a solution, the plate 31 (and/or the suction cup 30) may comprise a (radial) tab 312, see FIGS. 27-34) protruding laterally with respect to the guide bar 21 (e.g. outside or at the notch 2110), so as to facilitate gripping thereof and, therefore, lifting from the slab L to facilitate detachment when required.

In any case (when, for example, the suction cup 30 protrudes outside the guide bar 21), the suction cup 30 comprises a (rigid) abutment cup, interposed between the lower surface of guide bar 21 and the plate 31, which defines an abutment surface for the plate 31 of the suction cup 30.

An auxiliary rest foot 300 (see FIG. 13 or FIGS. 30 and 31) can be derived from the abutment cup, e.g. as a single body with it, which protrudes (radially and/or axially/below) from the abutment cup and protrudes below (towards the slab L), e.g. on the side opposite the part wherein the (only) rest foot 211 is provided (in the version illustrated in FIG. 13).

The auxiliary foot 300, for example, can comprise a resilient support element for the slab L, which is, for example, coplanar to the plane on which the rest foot 211 rests and parallel to the smaller base of the guide bar 21 (or it may rest directly on the slab L, for example being made of plastic).

The auxiliary foot 300 defines a punctual rest of the guide bar 21 on the slab L at the suction cup 30.

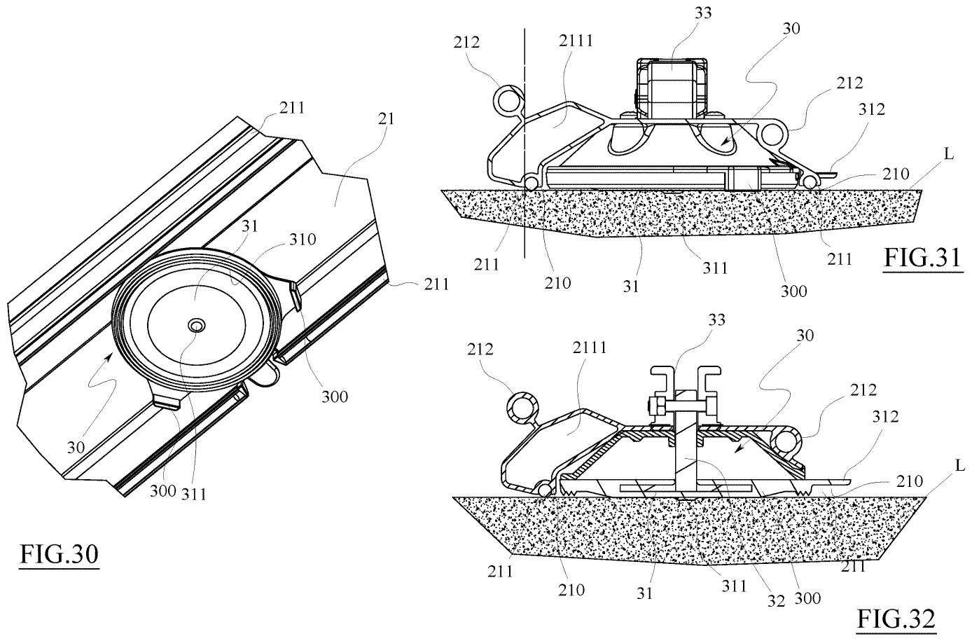

In the example shown in FIGS. 30 and 31, the rest foot 300 (in the example, in number of 2 angularly separated) is arranged below the guide bar 21, i.e. below the smaller base thereof.

Preferably, the rest foot 300 is derived below the lower surface of the plate 31 defining the point of (first) contact of the suction cup with the slab L and, thus, facilitating the detachment of the plate 31 from the slab L when removing the suction cup 30).

In the example shown in FIGS. 10-12, the plate 31 is laterally contained between the lateral portions of the lower surface of the guide bar 21 and it abuts at the top against at least one portion (e.g. defined by two internal brackets—parallel to the smaller base—opposite and symmetrical with respect to the longitudinal median plane derived internally from the inclined sides of the guide bar 21. In this way, the brackets define an abutment surface for the plate 31 of the suction cup 30.

The plate 31 is elastically deformable, and is variously configurable between at least two configurations, of which an undeformed or release configuration (when it is not subjected to any stress), in which it is substantially planar, and a deformed or gripping configuration (when it is subjected to an upward pulling action from a central zone thereof), in which it is substantially concave with a concavity turned below.

The plate 31, for example, has an upper surface, the perimeter portion of which is configured to forcibly abut the abutment surface defined by the abutment cup or the aforementioned brackets when the plate is brought into its deformed configuration.

Further, the plate 31 has a gripping surface (lower, opposite to the upper surface), which defines the rest and gripping (planar) surface of the suction cup 30 on the slab L.

In addition, the gripping surface of the plate 31 of the suction cup 30 globally defines a rest (plane of) for the support 20 (i.e. for the guide bar 21) on the (visible surface of the) slab L, i.e. such that it supports the guide bar on the slab L.

When the plate 31 with its gripping surface rests on the visible surface of the slab L, the guide bar 21 (with its rest foot(feet) 211 resting on the same visible surface of the slab L) is held in (indirect) support on the slab L with its smaller base (substantially) parallel to the visible surface of the slab.

The gripping surface of the plate 31 could be (predominantly) smooth or substantially smooth (and planar).

Advantageously, the gripping surface of the plate 31 is textured (i.e. not totally smooth).

For example, the plate 31, i.e. the gripping surface of the plate 31, comprises at least one circular gripping lip 310, for example peripheral (i.e. arranged near or at an outer peripheral end of the plate 31).

The gripping lip 310 extends circumferentially over an entire turn delimiting a closed perimeter (of the plate 31).

The gripping lip has, in section (with respect to any radial plane, i.e. a plane to which the central axis of the suction cup belongs), a pointed shape (below), for example rectangular. Preferably but not in a limiting manner, the plate 31, i.e. the gripping surface, comprises a plurality of (identical) mutually concentric gripping lips 310, for example with gradually decreasing diameter as they move away from the periphery of the plate.

The gripping lip 31 is configured to come into (forced) contact with the visible surface of the slab L, so as to circumferentially delimit a (variable) gripping volume of the suction cup 30.

Still, preferably but not in a limiting manner, the plate 31, i.e. the gripping surface thereof, comprises a detachment relief 311 circumscribed within the gripping lip.

The detachment relief 311 is for example substantially discoidal (and concentric with the gripping lip 310) and radially separated from the (innermost) gripping lip 310 by a gripping gap (left empty), which defines the (variable) gripping volume of the suction cup 30.

The detachment relief 311 has a lower face turned towards the slab L intended to push on it to facilitate the detachment of the plate 31 from the surface of the slab L held by the plate itself.

For example, when the plate 31 is in its undeformed configuration it is substantially planar, whereas when the plate 31 is in its deformed configuration it has a (slight) concave shape (with concavity turned downwards) or remains substantially planar.

The detachment relief 311, when the plate 31 is in its undeformed configuration, protrudes axially (below) from the gripping lip or is flush with (the apex of) the gripping lip.

For example, when the plate 31 is in its undeformed configuration, the detachment relief 311 is substantially flush (or coplanar) with the lower end of the rest foot(feet) 300 where present.

When the plate 31 is in its deformed configuration, the detachment relief 311—by effect of the deformation—retracts (totally or at least partially) inside the axial encumbrance of the gripping lip 311 (not in contact with the slab L).

The suction cup 30 further comprises a traction stem 32, which is derived (above) from the plate 31, for example coaxially thereto.

The traction stem 32, for example prismatic, rises substantially squared from the upper surface of the plate 31.

For example, the traction stem 32 is engaged and/or partially embedded (by means of a stiffening and fixing plate) in the plate 31.

Alternatively or additionally, it is possible to provide that the plate 31 and traction stem 32 are made of the same material and, even more preferably, the plate 31 and traction stem 32 are in a single piece with each other.

In other words, the suction cup 30 (formed by the plate 31 and by the traction stem 32) is made in a (mono-material or multi-material) single-piece body.

Advantageously, the suction cup 30 (i.e. the plate 31 and/or the traction stem 32) are centred on the longitudinal median plane of the guide bar 21 (or better of the smaller base thereof), i.e. an axial median plane of the suction cup 30 coincides with the longitudinal median plane of the guide bar 21.

For example, the traction stem 32 is inserted axially within a through-hole of the guide bar 21 (i.e. made in the smaller base thereof), so as to protrude above the (smaller base) of the upper surface thereof.

The protruding portion of the traction stem 32 is preferably bifurcated (forked) and has a cylindrical seat with axis orthogonal to the longitudinal axis A of the guide bar 21 and parallel to the rest plane thereof on the slab L).

Advantageously, the traction stem 32, i.e. its portion emerging above the guide bar 21, is connected to traction means (arranged on the opposite side of the guide bar 21 with respect to the plate 31), preferably cam means, for example formed by a lever 33 hinged to the traction stem 32 (through a hinge pin inserted in the cylindrical seat) and provided with a cam that is eccentric with respect to the hinging axis placed at one end of the lever opposed to the free gripping end thereof.

The cam is configured to act against the upper surface of the guide bar 21, so as to define an axial pull on the traction stem 32 (and therefore the passage from the undeformed configuration of the plate 31 to the deformed configuration thereof) following a rotation of the lever 33 and of the respective cam, respectively from a zone with a smaller thickness of the cam to a zone with a greater thickness thereof.

The cam is configured to define two stable equilibrium positions for the lever 33, of which a maximum pulling position corresponding (to the maximum thickness of the cam and) to the configuration deformed by the plate 31 and a minimum pulling position (or zero pull) corresponding (to the minimum thickness of the cam and) to the configuration undeformed by the plate 31.

Between the two stable equilibrium positions, the lever 33 travels through an arc of oscillation, e.g. substantially 180° (or 90°).

In the two stable equilibrium positions, the lever 33 is substantially parallel to the guide bar 21.

Advantageously, the system 10 comprises a plurality of suction cups 30 (as described above), for example spaced apart along the longitudinal axis A of the guide bar 21.

Preferably, the suction cups 30 are aligned with each other and, for example, equidistant from each other.

In the example, to the guide bar 21 there are fixed no. 3 suction cups, of which a central suction cup (arranged at the centre line of the guide bar 21).

The guide bar 21 therefore has a notch 2110 for each suction cup 30, where provided. The axial position of each notch 2110 is such that a median plane of the respective suction cup 30 orthogonal to the longitudinal axis of the guide bar 21 is essentially a median plane of the notch 3110 (and, for example, it cuts the traction stem 32 of the suction cup 30 in half).

The system 10, for example, could comprise a plurality of guide bars 21 (with the respective suction cups 30), for example identical to each other (as described above).

In this case, the guide bars 21 can be interconnected with each other so that each of them axially extends another guide bar 21 (i.e. so as to define a long guide bar 21 composed of the set of several guide bars 21 axially aligned and adjacent to each other).

Preferably, for this purpose, each guide bar 21 comprises interconnecting means 40 (see, in particular, FIGS. 2 and 3 or FIGS. 27 and 28) configured to interconnect, preferably in a releasable manner, two consecutive, coaxial guide bars 21.

For example, the interconnecting means 40 comprise a hooking 41, for example a lever hooking, which is located at/near a first axial end of one (preferably each) guide bar 21, for example at the upper surface thereof (for example the smaller base thereof).

Furthermore, the interconnecting means 40 comprise an abutment element 42 for the hooking 41, for example a retaining tab, which is placed at/in proximity of a second axial end (opposite to the first axial end) of one (preferably each) guide bar 21, for example at the upper surface thereof (preferably of the smaller base thereof).

When two guide bars 21 are aligned (coaxial) and contiguous (seamless) with each other, with the first axial end of one guide bar 21 in contact with the second axial end of another guide bar 21, the hooking 41 is configured to hook (in a releasable manner) with the abutment element 42, holding the two guide bars 21 in the position of mutual axial extension.

The interconnecting means 40, for example, further comprise one or more (in the example two in number) pins 43 (of reinforcement of the connection between the guide bars 21), configured to be fitted (simultaneously) in special axial seats made in the support bars 21, for example at each first axial end and second axial end thereof.

Preferably, each pin 43 has a longitudinal axis parallel to the longitudinal axis A of the guide bars 21 that interconnects and has a first axial end section inserted in an axial seat of a guide bar 21 and a second axial end section inserted in an axial seat of a further guide bar 21.

For example, when two guide bars 21 are aligned (coaxial) and contiguous (seamless), with the first axial end of one guide bar 21 in contact with the second axial end of another guide bar 21, each pin 43 is retractable within the guide bars 21.

In the example illustrated, the axial seats of the guide bars 21 are defined internally to each (axial end of each) sliding rail 212 (i.e. defined by the axial inner cavity thereof) and/or to the further cylindrical longitudinal chamber.

The system 10 further comprises an engraving slider 50, which is configured to slide along a (single) sliding direction parallel to the longitudinal axis A of the guide bar 21 and make an engraving (or scoring) on the visible surface of the slab L (on which the guide bar rests), along an (rectilinear) engraving line parallel to the longitudinal axis of the guide bar 21 itself.

The engraving slider 50 comprises a main body 51, which is, for example, substantially rigid.

The main body 51 is defined by a single piece, e.g. shaped (preferably substantially pyramid-shaped with a triangular base).

The engraving slider 50 comprises, in one upper zone thereof, a handle zone (or grasping zone) configured to define a rest and gripping surface for (the palm of) a (single) hand of a user operating the sliding along the sliding direction (on the guide bar 21).

In more detail, the engraving slider 50 comprises a handle 510 located in the aforementioned handle zone.

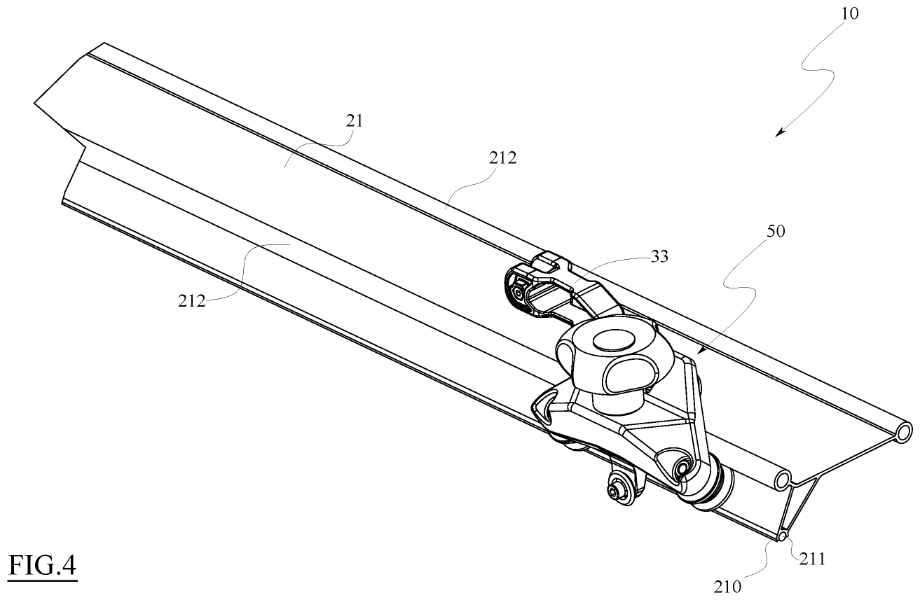

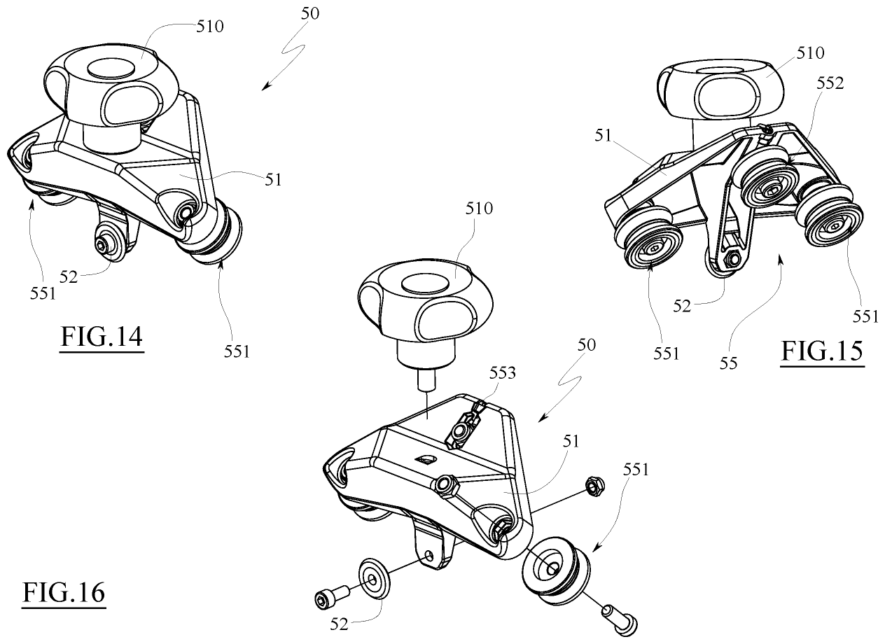

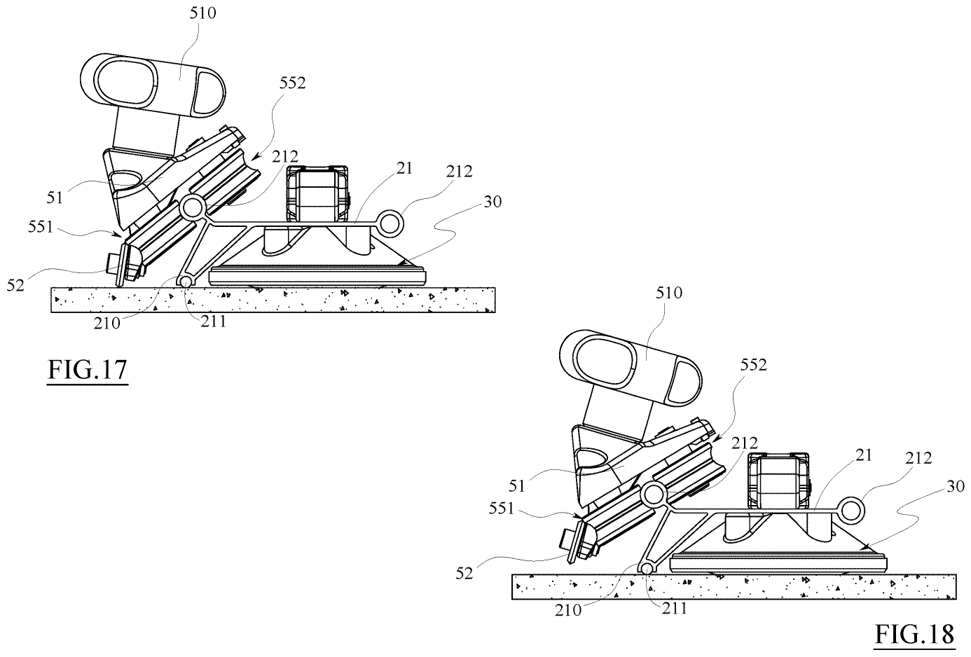

In a first embodiment shown in FIGS. 4-7, 12-18 and 21-24 as well as in FIGS. 27-34, the handle 510 comprises a knob (e.g. provided with an enlarged head preferably provided with gripping footprints), which is, for example, made in a separate body and fixed to the main body 51 of the engraving slider 50, e.g. screwed thereto and/or rigidly fixed by means of another suitable fixing system.

The head of the knob, in such a case, defines a rest and gripping surface for a hand of the user which allows to exert a suitable pressure (or thrust along a thrust axis orthogonal to the visible surface of the slab L on which the engraving slider 50 and/or the support 20 rests) of the engraving slider 50 on the slab L and a thrust thereon to determine its sliding along the sliding direction.

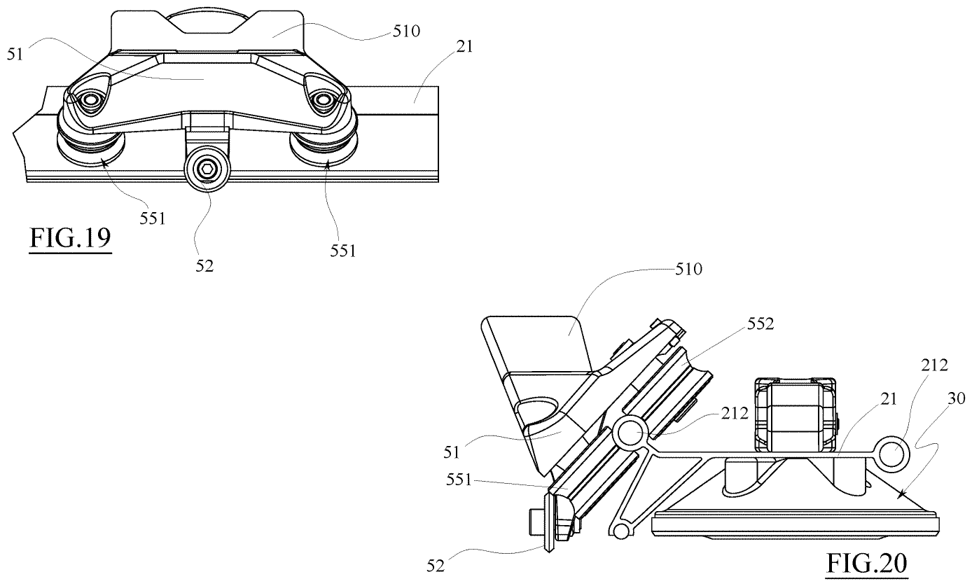

In a second embodiment shown in FIGS. 19-20 and 25-26, the handle 510 comprises an anatomical housing for gripping and/or housing by a user's hand.

In such a case, the handle 510, i.e. the aforesaid print, can be made in one single body with the main body 51 of the engraving slider 50.

For example, the main body 51 of the engraving slider 50 is arranged substantially on the side (flanked) to the support 20 (i.e. to the guide bar 21), along a flanking direction orthogonal to the longitudinal axis A of the support 20 (i.e. to the guide bar 21), i.e. so as to be able to overlap in plan with the visible surface of the slab L (when the support 20 is resting thereon).

The handle 50 is, in practice, aligned in plan (in a direction orthogonal to the visible surface of the slab L on which the support 20 rests) with a portion of the visible surface of the slab L (located at the side of the support).

The engraving slider 50 is provided with at least one engraving wheel 52 (or other suitable engraving body), which is configured to generate an engraving or scoring line on the visible surface of the slab L (on which the support rests), during the sliding of the engraving slider 50 along the sliding direction on the support 20.

The engraving wheel 52 is preferably rotatably associated with the engraving slider 50, i.e. to the main body 51 thereof, about an axis of rotation that is always orthogonal to the longitudinal axis A of the support 20 (i.e. of the guide bar 21).

In practice, the axis of rotation of the engraving wheel 52 (always) lies on a plane orthogonal to the longitudinal axis A (i.e. to the sliding direction of the engraving slider 50 with respect to the support 20).

The engraving slider 50 is designed so that the axis of rotation of the engraving wheel 52 is substantially parallel to the visible surface of the slab L to be engraved (i.e. to the rest plane of the support 20 thereon), when it is resting (with its cutting edge) on the visible surface of the slab L.

The (idle) rotation of the engraving wheel 52 about its axis of rotation allows the rolling of (the cutting edge of) the engraving wheel itself on the visible surface of the slab L during the sliding of the engraving slider 50 along the sliding direction on the support 20 and, therefore, the realization of a longitudinal engraving (parallel to the longitudinal axis A) of an engraving line on the visible surface of the slab L.

The engraving wheel 52 (i.e. its axis of rotation) is aligned (in plan) along an alignment direction orthogonal to the axis of rotation to the handle zone (i.e. the handle 510), so that a force directed towards the slab L imparted on the handle 510 can result in a force (of equal magnitude) of (the cutting edge of) the engraving wheel 52 on the visible surface of the slab L.

The engraving wheel 52 is supported in rotation by a support arm derived (below) from the main body 51 (e.g. in a single body with it).

For example, the support arm is centred on a vertical median plane of the main body 51 orthogonal to the longitudinal vertical median plane of the guide bar 21.

For example, the engraving wheel 52 (see FIG. 16 or FIG. 34) is keyed on an (outer ring of a) bearing, preferably a single bearing, which—in turn—(has an inner ring that) is mounted on a rotation pin fitted into the support arm.

In the example, the rotation pin is formed by a bolt fitted into a through-hole of the support arm.

The engraving slider 50 could comprise a single engraving wheel 52, like in the illustrated cases, or a plurality of engraving wheels 52.

In the case where the engraving slider 50 comprises a plurality of engraving wheels 52, these would preferably have axes of rotation parallel to each other.

For example, it is possible to provide that the engraving slider 50 comprises two (or more) engraving wheels 52 aligned with each other (so as to lie on the same engraving line made by them).

In practice, the cutting edges of the engraving wheels 52 are aligned with each other along (and at the same height as) the engraving line (orthogonal to the axis of rotation).

In such an embodiment, the engraving wheels 52 could all have the same diameter (and having coplanar axes of rotation on a plane parallel to the engraving line tangent to the cutting edge thereof) or, preferably, have mutually different diameters (in this case having axes of rotation parallel to each other but not belonging to the same plane parallel to the engraving line tangent to the cutting edge thereof).

Still, in such an embodiment, the engraving wheels 52 could all have the same sharpening degree (or the same sharpening profile) or, preferably, have a different sharpening degree (or the same sharpening profile) between them.

In the latter case, for example, a second engraving wheel 52 placed downstream of a first engraving wheel 52 in the engraving direction along the longitudinal axis of the sliding rail 212 could have a greater sharpening degree (i.e. a more pointed sharpening profile), so as to enter in the (and retrace the) engraving line made by the first engraving wheel 52.

In such a case, for example, the engraving slider 50 could have three engraving wheels 52, of which a second engraving wheel 52 interposed (along the alignment direction parallel to the longitudinal axis A of the sliding rail 212) between two first engraving wheels 52 (so that in whatever engraving direction the engraving slider is operated the second engraving wheel 52 is always downstream of a first front engraving wheel 52).

For example, the second engraving wheel 52 could have a diameter smaller than the diameter of (each) first engraving wheel 52 (which have, for example, the same diameter and/or the same sharpening degree/sharpening profile).

The axis of rotation of the engraving wheel 52 is fixed with respect to the engraving slider 50 (i.e., it is arranged on a fixed axis of the main body 51 of the engraving slider itself).

(The cutting edge of) the engraving wheel(s) 52, when in contact with the slab L, lies (and rolls) in a lying plane orthogonal to the lying plane defined by the rest feet 211 of the guide bar 21 arranged at the side of the guide bar itself, i.e., at a part thereof), so as to slide (rolling on the slab L) along that plane parallel to the longitudinal axis of the guide bar 21.

The projection of the sliding rail 212 (proximal to the engraving wheel 52) on this rest plane is interposed (transversely) between the lying plane (of the cutting edge) of the engraving wheel 52 and the rest foot 211 proximal to the engraving wheel 52, preferably between the lying plane and the aforesaid tangency plane.

The system 10, more precisely the engraving slider 50, comprises a connecting assembly 55, which is configured to interconnect the engraving slider 50 to at least one sliding rail 212 of the support 20 (i.e. of the guide bar 21), preferably to a single sliding rail 212 of the support 20 (i.e. of the guide bar 21).

In practice, the connecting assembly 55 is configured to allow and/or guide the sliding of the engraving slider 50 with respect to the (single) sliding rail 212 along the longitudinal axis A of the support 20 (i.e. of the guide bar 21).

The connecting assembly 55 interconnects the engraving slider 50 and a single sliding rail 212 (preferably the sliding rail 212 that is derived above the smaller base of the guide rail 21 or the one proximal to the engraving wheel 52, when the engraving slider 50 is connected to the guide rail 21) and, preferably, defines a shape constraint with the single sliding rail itself.

In practice, the connecting assembly 55 (and hence the engraving slider 50) can be engaged with one (only) of the sliding rails 212 (leaving the other one free), for example the one proximal (or superimposed) to the rest foot 211 (in case there is only a single or double one).

It could be provided that the connecting assembly 55 (and thus the engraving slider 50) could be selectively engaged with one (or the other) of the sliding rails 212 (leaving the other one free), depending on the engraving requirements.

In particular, the shape constraint constraining the engraving slider 50 to the single sliding rail 212 (via the connecting assembly 55) is such as to allow a mutual coupling between the engraving slider 50 (i.e., the connecting assembly 55) and the sliding rail 212 such as to allow at least one mutual degree of freedom, wherein said (always) allowed degree of freedom is a translational degree of freedom (sliding, preferably without dragging) along the longitudinal axis A of the support 20 (i.e. of the guide bar 21 and/or sliding rail 212).

The connecting assembly 55 comprises at least one first connecting element 551, constrained to the main body 51 of the engraving slider 50, which is configured to contact a first contact portion of the sliding rail (212).

In addition, the connecting assembly 55 comprises at least one second connecting element 552, also constrained to the main body 51 of the engraving slider 50, which is opposite, for example with respect to the longitudinal/central axis of the sliding rail 212, preferably diametrically opposite (i.e. at an angle of opposition substantially equal to 180°) or in any case at an angle of opposition comprised in an arc of opposition ranging from 90° to 270°) to the first connecting element 551 and is configured to contact a second contact portion of the same opposite sliding rail 212, preferably diametrically opposite, to the first contact portion in contact with the first connecting element 551.

In detail, the first connecting element 551 and the second connecting element 552 insist on opposite (first and second) contact portions of the (same) sliding rail 212, wherein the first contact portion is circumscribed within an arc of opposition (around the longitudinal/central axis of the sliding rail 212) with respect to the second contact portion, wherein this arc of opposition ranges from 90° to 270° and, preferably, is equal to 180°.

In other words, the first connecting element 551 is rotated (about the longitudinal/central axis of the sliding rail 212) by an opposite angle comprised in an arc of opposition ranging from 90° to 270°, preferably equal to 180°, with respect to the second connecting element 552. According to the invention, at least one of the first connecting element 551 and the second connecting element 552 (or both) comprises at least one rolling body configured to roll, without dragging, on the sliding rail 212.

Advantageously, at least one of the first connecting element 511 and the second connecting element 552 is configured to at least partially embrace the sliding rail 212, in such a case coming into contact with a respective (enlarged) contact portion that is developed over a predetermined non-zero (acute) arc of contact, for example between 20° and 90°, preferably in the region of 45°.

The constraint defined by the connecting assembly 55 with the sliding rail 212 via the connecting assembly 55 (e.g., as designed above), preferably, is configured to prevent movements, preferably translations (away from/closer to the sliding rail 212) of the engraving slider 50 in any direction orthogonal to the longitudinal axis of the sliding rail 212, or to prevent radial displacements of the engraving slider 50 relative to the sliding rail 212. Preferably, the shape constraint is (also) configured to allow (in addition to the aforesaid translation) also a rotation, preferably an oscillation (contained within a predetermined arc of oscillation) around the longitudinal (and central) axis of the sliding rail 212.

In particular, the shape constraint is defined by a substantially cylindrical coupling between the connecting assembly 55 and the (single) sliding rail 212 (with which the connecting assembly 55 interacts).

The first connecting body 551 and the second connecting body 552 are, for example, placed below the main body 51, on the opposite side with respect to the handle 510 thereof.

The first connecting body 551 is e.g. proximal to the lower end (of the triangular base) of the main body 51, i.e. proximal to the engraving wheel 52, e.g. at a (major) side of the triangular base of the main body 51.

The second connecting body 552 is for example proximal to the upper end (of the triangular base) of the main body 51, i.e. distal from the incision wheel 52, e.g. at a vertex of the triangular base of the main body 51 opposite the (aforesaid major) side.

In a first (and preferred) embodiment shown in FIGS. 1-7, 12-20, and also in the embodiment shown in FIGS. 27-34, both the first connecting body 551 and the second connecting body 552 comprise (or consist of) at least one rolling body, each configured to roll on the respective contact portion of the same sliding rail 212, about rolling axes orthogonal to the longitudinal axis A of the sliding rail and, preferably, parallel to each other.

In detail, the first connecting body 551 comprises at least one first wheel with a concave profile, which is configured to partially embrace the sliding rail 212, around said arc of contact, i.e. determining with it a first circumferentially extended contact portion.

Preferably, the first connecting body 551 comprises a plurality of concave-profile first wheels, for example a pair of concave-profile first wheels aligned with each other with respect to an alignment direction parallel to the longitudinal axis A of the sliding rail 212, i.e., such that they insist on the same first (circumferential) contact portion.

Each first wheel is rotatably coupled (idly) to the main body 51 about a respective (fixed) rolling axis (orthogonal to the longitudinal axis of the sliding rail 212), e.g. inclined by a predetermined (fixed) angle with respect to the axis of rotation of the engraving wheel 52 (e.g., substantially equal to 45°), wherein the rolling axes of the first wheels are parallel (and separate) to each other.

For example, each first wheel is supported on a respective rolling bearing (in turn supported by a pin, e.g. defined by a bolt fitted into a respective cylindrical seat made in the main body 51).

In such a first embodiment, the second connecting body 552 comprises at least a second wheel with a concave profile, which is configured to partially embrace the sliding rail 212, around said arc of contact, i.e. by determining with it a second contact portion (opposite, preferably diametrically, to the first contact portion) circumferentially extended.

Preferably, the second connecting body 552 comprises a single second concave-profile wheel.

The second wheel is rotatably coupled (idly) to the main body 51 about a respective rolling axis (orthogonal to the longitudinal axis of the sliding rail 212), for example inclined at a predetermined (fixed) angle with respect to the axis of rotation of the engraving wheel 52 (e.g., substantially equal to 45°), wherein the rolling axis of the second wheel is, preferably, belonging to a plane of symmetry of the rolling axes of the first wheels.

For example, the second wheel is supported on a rolling bearing (in turn supported by a pin, e.g. defined by a bolt fitted into a seat made in the main body 51).

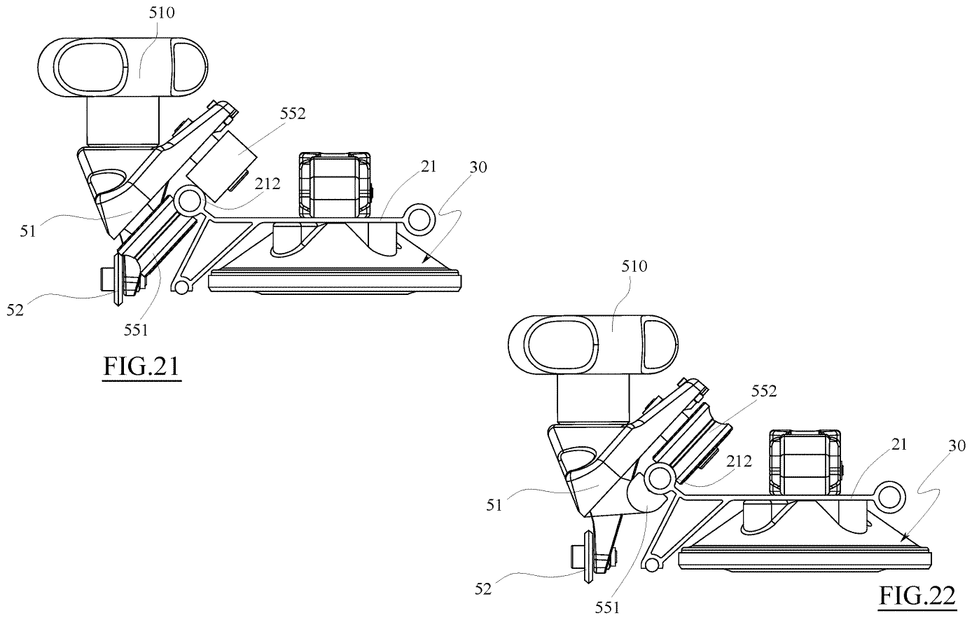

In a second embodiment shown in FIG. 21, both the first connecting body 551 and the second connecting body 552 comprise (or consist of) at least one rolling body, each configured to roll on the respective contact portion of the same sliding rail 212, around rolling axes orthogonal to the longitudinal axis A of the sliding rail and, preferably, parallel to each other.

In this second embodiment, one of the first connecting body 551 and the second connecting body 552 comprises a first concave-profile wheel and the other of the second connecting body 552 and the first connecting body 551 comprises a second flat-profile wheel. In detail, the first connecting body 551 comprises at least one first wheel with a concave profile, which is configured to partially embrace the sliding rail 212, around said arc of contact, i.e. determining with it a first circumferentially extended contact portion.

Preferably, the first connecting body 551 comprises a plurality of concave-profile first wheels, for example a pair of concave-profile first wheels aligned with each other with respect to an alignment direction parallel to the longitudinal axis A of the sliding rail 212, i.e., such that they insist on the same first (circumferential) contact portion.

Each first wheel is rotatably coupled (idly) to the main body 51 about a respective (fixed) rolling axis (orthogonal to the longitudinal axis of the sliding rail 212), e.g. inclined by a predetermined (fixed) angle with respect to the axis of rotation of the engraving wheel 52 (e.g., substantially equal to 45°), wherein the rolling axes of the first wheels are parallel (and separate) to each other.

For example, each first wheel is supported on a respective rolling bearing.

In such a second embodiment, the second connecting body 552 comprises at least a second flat-profile wheel, which is configured to contact the sliding rail 212 substantially on a contact line, i.e., resulting in a second (preferably diametrically opposite to the first contact portion) contact portion that is substantially punctual (i.e., circumferentially limited) therewith.

Preferably, the second connecting body 552 comprises a single second flat-profile wheel. The second wheel is rotatably coupled (idly) to the main body 51 about a respective rolling axis (orthogonal to the longitudinal axis of the sliding rail 212), for example inclined at a predetermined (fixed) angle with respect to the axis of rotation of the engraving wheel 52 (e.g., substantially equal to 45°), wherein the rolling axis of the second wheel is, preferably, belonging to a plane of symmetry of the rolling axes of the first wheels.

For example, the second wheel is supported on a rolling bearing.

In further embodiments (shown in FIGS. 22-24), it is possible to provide that one of the first connecting element 551 and the second connecting element 552 comprises a rolling body, and the other of the second connecting element 552 and the first connecting element 551 comprises at least one sliding shoe configured to drag (without rolling) on the sliding rail 212.

In a third embodiment shown in FIG. 22, in particular, one of the first connecting body 551 and the second connecting body 552 comprises a first concave-profile wheel, and the other of the second connecting body 552 and the first connecting body 551 comprises a concave-profile sliding shoe.

In detail, the first connecting body 551 comprises at least one concave-profile sliding shoe, which is configured to partially embrace the sliding rail 212, around said arc of contact, i.e. resulting in a circumferentially extended first contact (and dragging) portion with it.

Preferably, the first connecting body 551 comprises either a single (elongated) concave-profile sliding shoe or a plurality of concave profile sliding shoes, for example a pair of concave-profile sliding shoes, aligned with each other relative to an alignment direction parallel to the longitudinal axis A of the sliding rail 212, i.e., such that they insist on the same first (circumferential) contact portion.

Each first sliding shoe is rigidly coupled to the main body 51.

In such a third embodiment, the second connecting body 552 comprises at least a second wheel with a concave profile, which is configured to partially embrace the sliding rail 212, around said arc of contact, i.e. by determining with it a second circumferentially extended (rolling) contact portion (opposite, preferably diametrically opposite, to the first contact portion) that is substantially punctual (i.e. circumferentially limited).

Preferably, the second connecting body 552 comprises a single second concave-profile wheel.

The second wheel is rotatably coupled (idly) to the main body 51 about a respective rolling axis (orthogonal to the longitudinal axis of the sliding rail 212), for example inclined by a predetermined (fixed) angle with respect to the axis of rotation of the engraving wheel 52 (e.g., substantially equal to 45°), wherein the rolling axis of the second wheel is, preferably, belonging to a plane of symmetry orthogonal to the longitudinal axis of the sliding shoe.

For example, the second wheel is supported on a rolling bearing.

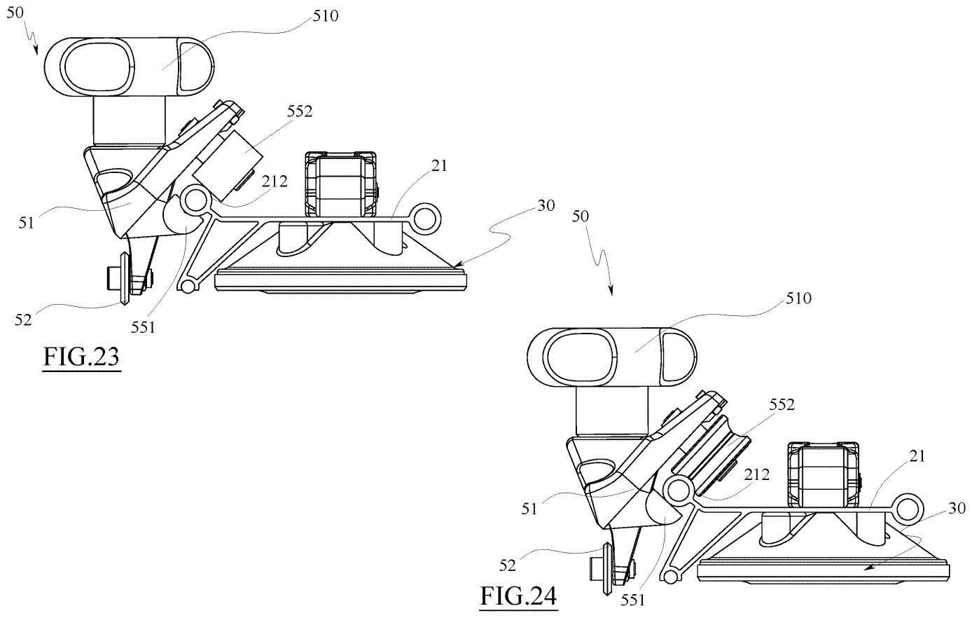

In a fourth embodiment shown in FIG. 23, in particular, one of the first connecting body 551 and the second connecting body 552 comprises a first flat-profile wheel and the other of the second connecting body 552 and the first connecting body 551 comprises a concave-profile (or flat-profile) sliding shoe.

In detail, the first connecting body 551 comprises at least one concave-profile sliding shoe, which is configured to partially embrace the sliding rail 212, around said arc of contact, i.e. resulting in a circumferentially extended first contact (and dragging) portion with it.

Preferably, the first connecting body 551 comprises either a single (elongated) concave-profile sliding shoe or a plurality of concave profile sliding shoes, for example a pair of concave-profile sliding shoes, aligned with each other relative to an alignment direction parallel to the longitudinal axis A of the sliding rail 212, i.e., such that they insist on the same first (circumferential) contact portion.

Each first sliding shoe is rigidly coupled to the main body 51.

In such a fourth embodiment, the second connecting body 552 comprises at least one second flat-profile wheel, which is configured to contact the sliding rail 212 substantially on a contact line, i.e., determining with it a second (preferably diametrically opposite to the first contact portion) contact portion that is substantially punctual (i.e., circumferentially limited).

Preferably, the second connecting body 552 comprises a single second flat-profile wheel. The second wheel is rotatably coupled (idly) to the main body 51 about a respective rolling axis (orthogonal to the longitudinal axis of the sliding rail 212), for example inclined by a predetermined (fixed) angle with respect to the axis of rotation of the engraving wheel 52 (e.g., substantially equal to 45°), wherein the rolling axis of the second wheel is, preferably, belonging to a plane of symmetry orthogonal to the longitudinal axis of the sliding shoe.

For example, the second wheel is supported on a rolling bearing.

Furthermore, in a fifth embodiment shown in FIG. 24, one of the first connecting body 551 and the second connecting body 552 comprises a first concave-profile wheel, and the other between the second connecting body 552 and the first connecting body 551 comprises a flat-profile sliding shoe.

In detail, the first connecting body 551 comprises at least one flat-profile sliding shoe, which is configured to contact the sliding rail 212 substantially on a contact line, i.e. determining a first substantially punctual (i.e. circumferentially limited) contact portion with it.

Preferably, the first connecting body 551 comprises either a single (elongated) flat-profile sliding shoe or a plurality of flat-profile sliding shoes, for example a pair of flat-profile sliding shoes, aligned to each other relative to an alignment direction parallel to the longitudinal axis A of the sliding rail 212, i.e. such that they insist on the same first (circumferential) contact portion.

Each sliding shoe is rigidly coupled to the main body 51.

In such a fifth embodiment, the second connecting body 552 comprises at least a second concave-profile wheel, which is configured to partially embrace the sliding rail 212, around said arc of contact, i.e. by determining with it a second contact portion (preferably diametrically opposite to the first contact portion) circumferentially extended.

Preferably, the second connecting body 552 comprises a single second concave-profile wheel.

The second wheel is rotatably coupled (idly) to the main body 51 about a respective rolling axis (orthogonal to the longitudinal axis of the sliding rail 212), for example inclined at a predetermined (fixed) angle with respect to the axis of rotation of the engraving wheel 52 (for example substantially equal to 45°), for example parallel to the plane defined by the flat-profile sliding shoe (belonging to a plane of symmetry orthogonal to the longitudinal axis of the sliding shoe).

For example, the second wheel is supported on a rolling bearing.

Further combinations of first and second connecting bodies are however possible, depending on construction requirements.

In each of the embodiments described above, it is possible to provide that at least one of the first connecting element 551 and the second connecting element 552 is movable closer to and/or away from the other of the second connecting element 552 and the first connecting element 551, for adjusting a gripping force thereof on the sliding rail 212.

In practice, the mutual movement closer to/away from the second connecting element 552 and the first connecting element 551 allows to adjust the clearance (respectively decreasing/increasing) of the connecting assembly 55 on the sliding rail 212 and/or to adjust the slidability (respectively increasing/decreasing) of the connection between the connecting assembly 55 and the sliding rail 212.

Preferably, the engraving slider 50 (and/or the connecting assembly 55) comprises adjustment means (see in particular FIG. 7 or FIG. 34) configured to adjust and lock the mutual distance between the first connecting element 551 and the second connecting element 552 and/or the gripping force on the sliding rail 212 thereof.

In the examples shown, the second connecting body 552 is movably associated with the main body 51 (while, for example, the second connection body 551 is fixed in relation to it).

In detail, the second connecting body 552 is slidably coupled to the main body 51 along a (single) sliding direction, e.g. orthogonal to the lying plane on which the axes of revolution of the first wheels (where provided) lie.

In detail, the axis of revolution of the second wheel (defining the second connecting body 552) is inserted into an elongated slot, with the possibility of sliding along it.

The adjustment means comprise a grub screw 553 (see FIG. 7 or FIG. 34) screwed into a special axially threaded seat extending the slot-elongated seat to define an axial (adjustable) end-of-stroke for the axis of revolution.

In addition, the adjustment means comprise a clamping bolt 554 onto which the second wheel is keyed (by means of the rolling bearing), which defines the rotation pin of the second wheel and, at the same time, the more or less loose tightening thereof blocks or allows the axis of revolution of the second wheel to slide along the slot-elongated seat.

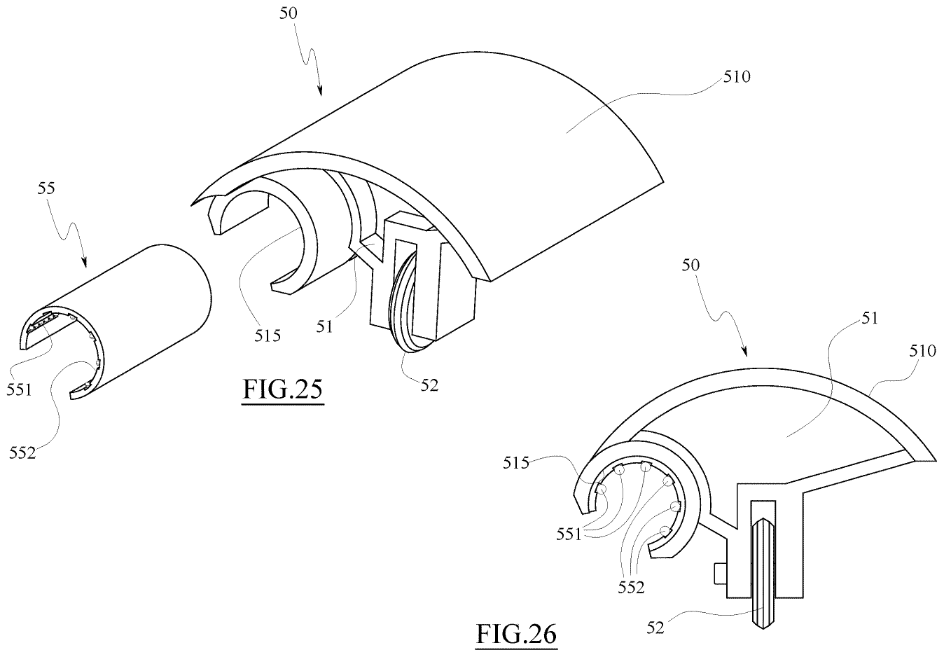

In a further and sixth embodiment shown in FIGS. 25-26, both the first connecting body 551 and the second connecting body 552 comprise (or consist of) at least one rolling body, each configured to roll on the respective contact portion of the same sliding rail 212. In detail, the engraving slider 50, i.e. its main body 51, is provided with a cylindrical seat having a (any) substantially C-shaped cross-section, which seat 515 is configured to accommodate therein the connecting assembly 55.

The connecting assembly 55 is for example (rigidly) fixed inside the seat 515, for example so that it can be replaced as needed.

For example, the connecting assembly 55 is fixed to the seat 515 by a mechanical connection, for example by interference or by interlocking or by fixing members (such as threaded members or other fixing member) or by gluing or the like.

In particular, the connecting assembly 55 comprises a support body in the form of a channel having a substantially C-shaped cross-section, preferably with a cylindrical inner section, wherein the channel is preferably provided with open axial ends and an opening, throughout its development, along a generatrix or side (such as to be crossed transversely by the fixing root of the sliding rail 212), so as to coaxially embrace an axial portion of sliding rail 212 with the possibility of sliding axially along it, preferably without the possibility of being removed radially/transversely therefrom by a translation along any (radial) direction orthogonal to the longitudinal axis of the sliding rail 212.

The opening (throughout its development) of the channel defined by the support body has a predetermined circumferential width, preferably greater than the circumferential width of the fixing root, so as to allow the oscillation of a predetermined arc of oscillation (between two end-of-stroke positions defined by the circumferential edges of the opening itself) of the support body (and therefore of the engraving slider 50 fixed thereto) with respect to the sliding rail 212.

The support body comprises at least one first seat, e.g. elongated along a direction of development parallel to the longitudinal axis thereof, and at least one second seat, preferably radially opposite to the first seat (around the central longitudinal axis of the sliding rail 212 on which the support body is coaxially fitted with radial clearance).

The first connecting element 551, which consists of a ball or a row of balls (which fills the first seat, i.e. extends along its direction of development over the entire length thereof), is accommodated within the first seat, with the possibility of rolling freely.

The second connecting element 552, which consists of a ball or row of balls (which fills the second seat, i.e. extends along its direction of development along its entire length), is accommodated within the second seat, with the possibility of rolling freely.

In particular, each ball or row of balls constituting the first connecting element 551 and the second connecting element 552 rolls, within its respective seat, on a respective (first or second) contact portion of the sliding rail 212, allowing the axial sliding of the engraving slider 51 on the sliding rail itself.

For example, it is possible to provide that the first connecting element 551 and the second connecting element 552 comprise a plurality of first seats, circumferentially (equally) spaced apart, e.g. to fill the entire channel defined by the aforesaid support body.

In such an embodiment, the connecting assembly 55 as a whole comprises or consists of a recirculating ball bearing (open along a line), wherein the first connecting element 551 and the second connecting element 552 are both part of the same recirculating ball bearing (diametrically) opposite to the central axis thereof.

In the light of what has been described above, the operation of the system 10 is as follows.

Once the engraving slider 50 has been coupled to the (single) sliding rail 212 of the support 20, this can be rested on the visible surface of a slab L to be engraved.

When the support 20 is in the desired position, it can be fixed on the slab L by acting on the suction cups 30 (i.e. on the levers 33 thereof).

In order to make the engraving line on the slab it is sufficient to grip the handle 510 of the engraving slider 50 and by simultaneously exerting a pressure towards the slab L and a thrust/traction along the longitudinal axis A it is possible to make the engraving slider 50 slide along the longitudinal axis A of the sliding rail 212, in this way the engraving wheel 52, rolling on the slab L, makes an engraving line on the visible surface of the slab L.

During such sliding motion, the rolling body constituting one of the first connecting element 551 and the second connecting element 552 of the connecting assembly 55 rolls on the sliding rail 212 and, the mutual arrangement between the first connecting element 551 and the second connecting element 552 (opposite to each other) as well as the possible conformation of one of the first connecting element 551 and the second connecting element 552 (such that it at least partially embraces the sliding rail 212) keeps the engraving slider 50 guided on the sliding rail 212 and imposes on the engraving wheel 52 a precise rectilinear trajectory that is parallel to the longitudinal axis A of the sliding rail itself.

When it is necessary to change the position of the support 20 (to perform a new engraving line) or to remove it, it is possible to act on the levers 33 of the suction cups, so as to release, in this way the detachment relief 311 detaches the gripping lip 310 from the visible surface of the slab L allowing the release of the suction cups 30 from it (where necessary the release action is assisted by the intervention—manually—on the protruding tabs 312 of the plates 31 of the suction cups 30).

The invention thus conceived is susceptible to many modifications and variants, all falling within the same inventive concept.

Moreover, all details may be replaced by other technically equivalent elements.

In practice, the materials used, as well as the contingent shapes and sizes, may be whatever according to the requirements without for this reason departing from the scope of protection of the following claims.

1. A slab cutting system comprising:
at least one support configured to rest on a slab to be cut and provided with at least one sliding rail developing along a longitudinal axis;
at least one engraving slider provided with at least one engraving wheel rotatable about an axis of rotation orthogonal to the longitudinal axis;
wherein the engraving slider comprises a connecting assembly interconnecting the engraving slider and the sliding rail for sliding the engraving slider relative to the sliding rail along the longitudinal axis thereof, wherein the connecting assembly comprises at least one first connecting element configured to contact a first contact portion of the sliding rail and at least one second connecting element opposite to the first connecting element and configured to contact a second contact portion of the same sliding rail opposite to the first contact portion in contact with the first connecting element, wherein the at least one of the first connecting element and the second connecting element comprises at least one rolling body configured to roll on the sliding rail.

2. The system according to claim 1, wherein the connecting assembly interconnects the engraving slider and the single sliding rail, and wherein the connecting assembly defines a shape constraint with the single sliding rail configured to allow an axial sliding of the engraving slider along the longitudinal axis of the sliding rail and to prevent translations of the engraving slider in any direction orthogonal to the longitudinal axis of the sliding rail.

3. The system according to claim 2, wherein the shape constraint is configured to allow an oscillation around the longitudinal axis of the sliding rail.

4. The system according to claim 1, wherein at least one of the first connecting element and the second connecting element is configured to at least partially embrace the sliding rail.

5. The system according to claim 1, wherein the axis of rotation of the engraving wheel is fixed with respect to the engraving slider.

6. The system according to claim 1, wherein one of the second connecting element and the first connecting element comprises a sliding shoe configured to drag on the sliding rail, wherein preferably the sliding shoe comprises a concave profile or a flat profile for contact on the sliding rail.

7. The system according to claim 1, wherein both the second connecting element and the first connecting element comprise at least one rolling body configured to roll on the sliding rail, about rolling axes orthogonal to the longitudinal axis of the sliding rail and, preferably, parallel to each other.

8. The system according to claim 1, wherein the rolling body comprises at least one concave-profile wheel or one flat-profile wheel for contact on the sliding rail.

9. The system according to claim 1, wherein at least one of the first connecting element and the second connecting element is movable closer to and/or away from the other of the second connecting element and the first connecting element, for adjusting a gripping force on the sliding rail.

10. The system according to claim 9, wherein the engraving slider comprises adjustment means configured to adjust and lock the mutual distance between the first connecting element and the second connecting element and/or the gripping force on the sliding rail thereof.

11. The system according to claim 1, wherein the rolling body comprises at least one ball or a row of balls, wherein preferably the connecting assembly and/or at least one of the first connecting element and the second connecting element comprises a re-circulating ball bearing.

12. The system according to claim 1, wherein the support is formed by at least one longitudinal guide bar and the sliding rail preferably develops over the entire longitudinal development of the guide bar, wherein preferably the sliding rail has a constant cross-section throughout its development, even more preferably substantially circular.

13. The system according to claim 12, comprising a plurality of guide bars and interconnecting means configured to releasably interconnect two consecutive and coaxial guide bars to each other.

14. The system according to claim 1, wherein at least one suction cup is connected to the support for the temporary and releasable fixing of the support to the slab.

15. The system according to claim 14, wherein the suction cup comprises a plate from which a traction stem and an abutment cup are derived, wherein the abutment cup is defined as integral or rigidly fixed to a lower surface of the support intended to face the slab.

16. The system according to claim 15, wherein at least one of the plate and the abutment cup comprises an element overlooking towards the slab and configured to forcibly contact the slab and facilitate the detachment of the plate from the slab, exerting a thrust away from it, when the plate is brought into an undeformed release configuration.

17. The system according to claim 1, wherein the substrate comprises a lower surface intended to face the slab, wherein the lower surface comprises at least one rest foot, preferably a single rest foot arranged on one side of the substrate proximal to the engraving wheel of the engraving slider or a pair of rest feet arranged on opposite sides of the substrate, wherein the rest foot is preferably made of a yielding and/or elastic and/or adhesive material or other material configured to grip the slab without damaging it.

18. The system according to claim 17, wherein the rest foot is elongated and has a longitudinal development parallel to the longitudinal axis of the sliding rail, wherein preferably the longitudinal development of the rest foot is continuous and equal to the longitudinal development of the sliding rail or, preferably in the case where a pair of rest feet is present, one of the two rest feet, advantageously the one distal from the engraving wheel of the engraving slider, is discontinuous in segments and extends over the entire longitudinal development of the sliding rail unless there are contained segments of discontinuity.

19. The system according to claim 14, wherein the suction cup comprises a slab gripping plate which has at least one portion protruding externally, preferably laterally, from the support, for example said protruding portion comprising a tab for gripping and detaching the plate from the slab.

20. The system according to claim 1, wherein the engraving slider comprises a handle, wherein the handle comprises at least one of a knob and an anatomical housing for gripping and/or housing by a user's hand, wherein the handle is made in a separate body and attached to the engraving slider or is made in a single body with it.
